(19) United States
(12) Patent Application Publication
(10) Pub. No.: US 2026/0105543 A1
(43) Pub. Date: Apr. 16, 2026

(54) APPARATUS AND METHOD FOR CHARGING AND DISCHARGING SCHEDULING OF ELECTRIC VEHICLE

(71) Applicants: HYUNDAI MOTOR COMPANY, SEOUL (KR); KIA CORPORATION, SEOUL (KR)

(72) Inventors: Hye Seung Han, Hwaseong-si (KR); Hyun Sup Kim, Hwaseong-si (KR); Min Kyu Lee, Hwaseong-si (KR); Jae Yun Jung, Hwaseong-si (KR); Bum Su Park, Hwaseong-si (KR); Na Yeon Park, Hwaseong-si (KR); Dae Gun Ko, Hwaseong-si (KR); Sung Kyu Kim, Hwaseong-si (KR); Jeong Hoon Choi, Hwaseong-si (KR)

(73) Assignees: HYUNDAI MOTOR COMPANY, SEOUL (KR); KIA CORPORATION, SEOUL (KR)

(21) Appl. No.: 19/209,442

(22) Filed: May 15, 2025

(30) Foreign Application Priority Data
Oct. 11, 2024 (KR) 10-2024-0138366

(51) Int. Cl. G06Q 50/06; B60L 53/62; B60L 53/68; B60L 55/00; G06Q 10/0631; G06Q 30/08

(52) U.S. Cl. CPC G06Q 50/06; B60L 53/62; B60L 53/68; B60L 55/00; G06Q 10/06314; G06Q 30/08

(57) ABSTRACT

An apparatus for charge and discharge scheduling of an electric vehicle is provided, the apparatus including one or more processors and a memory storing one or more programs executed by the one or more processors, wherein each of the one or more processors includes a first processing unit configured to classify a plurality of electric vehicles into a plurality of pools according to a participating market, a second processing unit configured to calculate a spare time index until a target energy completion point in time for each electric vehicle, a third processing unit configured to group the plurality of electric vehicles according to the spare time index, and a fourth processing unit configured to distribute a successful bid amount received from a demand management business operator server to each group using the spare time index.

### CROSS REFERENCE TO RELATED APPLICATIONS

This application claims priority to and the benefit of Korean Patent Application No. 10-2024-0138366, filed on Oct. 11, 2024, the disclosure of which is incorporated herein by reference in its entirety.

### BACKGROUND

### 1. Field

One embodiment of the present disclosure relates to an apparatus and method for charge and discharge scheduling of an electric vehicle.

### 2 Discussion of Related Art

As the spread of electric vehicles accelerates, research and business concerning utilizing high-voltage batteries installed in electric vehicles as energy storage systems (ESS) are actively being conducted. Energy storage systems may act as an energy source and perform a vehicle-to-grid (V2G) function that supplies energy through charging and discharging by being linked to a power system.

Managing scheduling for charging and discharging of an electric vehicle through the V2G function is an important issue. In recent years, as the spread of electric vehicles increases, the number of variables required to optimize the scheduling for charging and discharging is increasing as well, and this increase can result in problems such as an increase in computational dimensions, in complexity, and in time required to perform the optimization analysis.

### SUMMARY

The present disclosure is directed to providing an apparatus and method capable of managing electric vehicle resources in order to satisfy a successful bid amount received in an electricity market in which an electric vehicle participates.

The present disclosure is also directed to providing an apparatus and method for charging and discharging scheduling of an electric vehicle, capable of minimizing the time cost of an electric vehicle charging and discharging platform.

The present disclosure is also directed to providing an apparatus and method for charging and discharging scheduling of an electric vehicle, capable of deriving an optimal charging and discharging schedule of an electric vehicle platform.

According to an aspect of the present disclosure, there is provided an apparatus for charging and discharging scheduling of an electric vehicle, including one or more processors and a memory storing one or more programs executed by the one or more processors, in which each of the processors includes a first processing unit configured to classify a plurality of electric vehicles into a plurality of pools according to a participating market, a second processing unit configured to calculate a spare time index until a target energy completion point in time for each electric vehicle, a third processing unit configured to group the plurality of electric vehicles according to the spare time index, and a fourth processing unit configured to distribute a successful bid amount received from a demand management business operator server to each group using the spare time index.

The second processing unit may calculate the spare time index using an entry duration, target energy, and charging energy per hour of the electric vehicle.

The second processing unit may calculate the spare time index according to the following Equation 1,

$${LAX}_{i} = {d}_{i} - \frac{{e}_{i}}{{r}_{i}} \qquad [ Equation 1 ]$$

wherein in Equation 1, LAXᵢ is the spare time index, dᵢ is the entry duration [h], eᵢ is the target energy [kWh], and rᵢ is the charging energy per hour [KW].

The first processing unit may assign a pool ID to the electric vehicle according to the participating market.

The third processing unit may group the plurality of electric vehicles using the pool ID and the spare time index.

The third processing unit may group the plurality of electric vehicles using a K-means clustering algorithm according to a preset number of electric vehicles for each group.

The first processing unit may assign the pool ID according to a virtual power plant (VPP), demand response (DR), vehicle-to-home (V2H), and vehicle-to-building (V2B).

The fourth processing unit may calculate a sum of the spare time indexes for each group and distribute the successful bid amount according to a ratio of the sum.

The apparatus may further include a fifth processing unit configured to generate a charging and discharging schedule for the electric vehicle using the successful bid amount distributed to each group.

The fifth processing unit may generate the charging and discharging schedule so that a profit of the electric vehicle belonging to the group is maximized according to the successful bid amount for each group.

According to another aspect of the present disclosure, there is provided a method performed by a computing device having one or more processors and a memory storing one or more programs executed by the one or more processors, including classifying, by the processor, a plurality of electric vehicles into a plurality of pools according to a participating market, calculating, by the processor, a spare time index until a target energy completion point in time for each electric vehicle, grouping, by the processor, the plurality of electric vehicles according to the spare time index, and distributing, by the processor, a successful bid amount received from a demand management business operator server to each group using the spare time index.

In the calculating of the spare time index, the spare time index may be calculated using an entry duration, target energy, and charging energy per hour of the electric vehicle.

In the calculating of the spare time index, the spare time index may be calculated according to the following Equation 2.

$${LAX}_{i} = {d}_{i} - \frac{{e}_{i}}{{r}_{i}} \qquad [ Equation 2 ]$$

wherein in Equation 2, LAXᵢ is the spare time index, dᵢ is the entry duration [h], eᵢ is the target energy [kWh], and rᵢ is the charging energy per hour [kW].

The classifying of the plurality of electric vehicles into the plurality of pools may include assigning a pool ID to the electric vehicle according to the participating market.

In the grouping, the plurality of electric vehicles may be grouped using the pool ID and the spare time index.

In the grouping, the plurality of electric vehicles may be grouped using a K-means clustering algorithm according to a preset number of electric vehicles for each group.

The classifying of the plurality of electric vehicles into the plurality of pools may include assigning, by the processor, the pool ID according to a virtual power plant (VPP), demand response (DR), vehicle-to-home (V2H), and vehicle-to-building (V2B).

In the distributing of the successful bid amount to each group, the processor may calculate a sum of the spare time indexes for each group and distribute the successful bid amount according to a ratio of the sum.

The method may further include generating, by the processor, a charging and discharging schedule for the electric vehicle using the successful bid amount distributed for each group.

In the generating of the charging and discharging schedule, the charging and discharging schedule may be generated so that a profit of the electric vehicle belonging to the group is maximized according to the successful bid amount for each group.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings, in which:

FIG. 1 is a diagram for describing an electric vehicle power management system according to an embodiment;

FIG. 2 is a block diagram of a configuration of an electric vehicle charging and discharging scheduling apparatus according to an embodiment;

FIG. 3 is a diagram for describing the operation of the electric vehicle charging and discharging scheduling apparatus according to the embodiment of FIG. 2;

FIG. 4 is a diagram for describing the operation of a first processing unit according to the embodiment of FIG. 2;

FIG. 5 is a diagram for describing the operation of a third processing unit according to the embodiment of FIG. 2;

FIG. 6 is a diagram for describing the operations of the third processing unit and a fourth processing unit according to the embodiment of FIG. 2;

FIG. 7 is a diagram for describing the operations of the third processing unit and a fourth processing unit according to the embodiment of FIG. 2; and

FIG. 8 is a flowchart of a method of charging and discharging scheduling of an electric vehicle according to an embodiment.

### DETAILED DESCRIPTION

Hereinafter, preferred embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the embodiments of the present disclosure are for the purpose of describing the embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, in describing a component of embodiments of the present disclosure, terms such as first, second, A, B, (a), (b), etc. may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but identical or corresponding components are denoted by the same reference numerals regardless of figure numbers, and redundant descriptions thereof will be omitted.

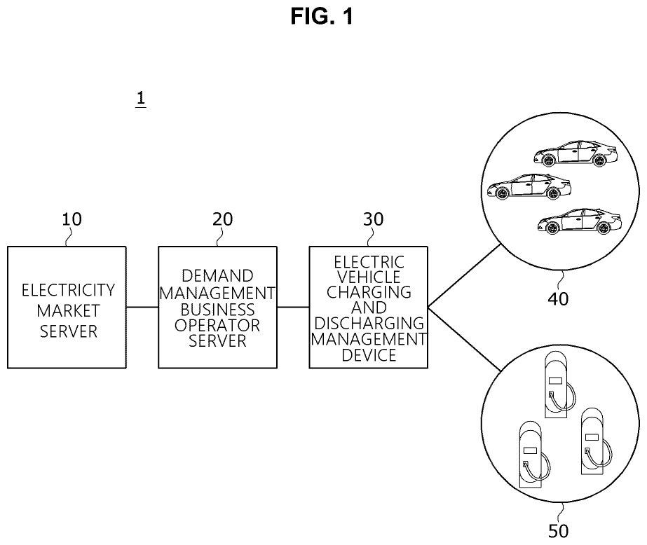

FIG. 1 is a diagram for describing an electric vehicle power management system according to an embodiment. Referring to FIG. 1, an electric vehicle power management system 1 may include an electricity market server 10, a demand management business operator server 20, and an electric vehicle charging and discharging management device 30.

The electricity market server 10 operates the electricity market and may perform settlement according to a participation amount for each resource in different manners according to market settlement rules. The electricity market server 10 may mediate power transactions between a plurality of demand management business operator servers 20 using power transaction request information received from the demand management business operator servers 20.

The electricity market server 10 may refer to a server that contracts with a demand management business operator for power usage and discharge business volume and distributes profits to the demand management business operator through demand response and time section-based power unit price.

The demand management business operator server 20 may perform power transactions using charging and discharging information received from the linked electric vehicle charging and discharging management device 30, renewable energy generation amount information of a connected renewable energy generation system, and power demand information of a linked system.

In the embodiment, the demand management business operator may refer to a business operator that contracts with a place that uses a large amount of electricity, such as a factory, a large building, or a parking tower, and performs power consumption reduction or the like according to demand response, thereby making a profit.

The power system linked to the demand management business operator may transmit power demand information to the demand management business operator server 20 at a preset cycle, upon request of the demand management business operator server, or when necessary. The power demand information may include power demand per hour and power usage reduction requirements of the linked system.

The demand management business operator server 20 may not only respond to the demand response through a request to reduce power usage, but also act like a power plant that transmits electricity that may be immediately used in the system using electric vehicles 40, electric vehicle batteries, ESS, or the like.

For example, the demand management business operator server 20 may receive a next day's charging and discharging amount from the electric vehicle charging and discharging management device 30 at a specific time every day and bid the amount to the electricity market server, and may receive the successful bid amount from the electricity market server 10 according to the preset cycle and transmit the successful bid amount to the electric vehicle charging and discharging management device 30.

The electric vehicle charging and discharging management device 30 may directly manage electric vehicles 40 and charging stations 50 of customers participating in the V2X service, and may receive information on electric vehicles 40 and chargers, plug-in/out signals, and the like. The electric vehicle charging and discharging management device 30 may control the charging and discharging of individual electric vehicles 40 to determine a next day's charging and discharging bid amount and fulfill the successful bid amount with the goal of maximizing market participation profits.

The electric vehicle charging and discharging management device 30 may monitor information on electric vehicles 40 and charging stations 50 and provide various data for customers. The electric vehicle charging and discharging management device 30 may perform functions such as billing settlement, parking space management, charge and discharge control command generation, transmission, charge and discharge scenario control, and vehicle battery state diagnosis, and the like.

The electric vehicle charging and discharging management device 30 may include a controller 31.

The power system may include smart grid-related systems such as, for example, a substation, an electricity market server, a demand management business operator server, a renewable energy source, an energy storage system (ESS), or the like. The renewable energy source may be an energy source using wind power, solar power, geothermal power, or waste. The power system may supply power within a range of allowable power (or maximum power) (Pmax) (or allowable alternating current (IACmax)) to the charging stations 50 under the control of the controller 31.

In some cases, when a large number of electric vehicles 40 are concentrated at charging stations 50 in a specific area at the same time, the maximum allowable power of the power system may vary. That is, by inputting a reserve power source such as an energy storage system (ESS) or inputting a surrounding renewable energy source in the electricity market server 10 that controls the system operation, the demand management business operator server 20, or the energy management system (EMS), the power capacity may be increased and the increased power may be supplied to the charging stations.

The allowable power may be increased by the controller 31 when the power supplied to the electric vehicles 40 is insufficient due to charging demand information about each electric vehicle 40 (charging demand amount of electric vehicle users). That is, the controller 31 may control a switch for additionally connecting (inputting) a renewable energy source (or energy storage system (ESS)) within the power system into a substation that supplies power to the charging stations 50 so that the allowable power of the power system increases when a charging load (a load of the electric vehicles) of the charging station 50 exceeds the allowable power of the power system.

The controller 31 may control the overall operation of components included in the electric vehicle charging and discharging management device 30. The controller 31 is an aggregator and may collect information on the battery capacity of the electric vehicle 40 connected to a charging station 50 through a wired or wireless communication network, a state of charge (SoC) of a battery of the electric vehicle 40, a rated current flowing through a power line, a rated voltage applied to the power line, or information on a charging request of an electric vehicle user (e.g., owner). The information on the charging request of the electric vehicle user may be transmitted to the controller 31 through a communication device included in each of the charging stations 50 or transmitted to the controller 31 through a communication device such as a user's mobile phone.

The controller 31 may exchange information with the power system through a wired or wireless communication network, and may exchange data with the charging station 50 through a LAN connection such as Ethernet, power line communication (PLC), or Wi-Fi, which is a wired or wireless communication network.

The controller 31 may control the power of the power system to be supplied to the charging station 50 within an allowable power range of the power system based on real-time information about the power system, state information about one of the electric vehicles 40, and charging demand information about each of the electric vehicles 40.

The real-time information about the power system may include information on the allowable power of the power system or information on the electricity rate of the power system, the state information about one of the electric vehicles 40 may include information (SoC) on a state of charge of the battery included in each electric vehicle 40, and the charging demand information may include a charging demand time, a scheduled entry time, a scheduled exit time, and a charging demand amount (target SoC) of an electric vehicle user.

The charging station 50 may charge batteries of a plurality of electric vehicles 40. Each charging station 50 may include an alternating current (AC) current limiter that performs current allocation operations to each electric vehicle 40. In addition, each charging station 50 may include a control module that exchanges information with a battery management system (BMS) of the electric vehicle 40 and the controller 31. By the control of the controller 31, the control module may control the current limiter (the AC current limiter) to provide a direct current charging current to each battery of the electric vehicle 40.

Each electric vehicle 40 may include the battery management system (BMS). The battery management system may control a battery charging process. Each electric vehicle 40 may function as an active load that demands power from the electric vehicle charging and discharging management device 30 during a charging time.

A charger that converts the alternating current of the power system into direct current to charge the battery of one of the electric vehicles 40 may be an on-board charger included in each electric vehicle 40 or an off-board charger included in each charging station 50.

The electric vehicle 40 may participate in electricity transactions by registering on a V2X platform. The user of one of the electric vehicles 40 may join the platform according to the electricity market the user wishes to participate in and register his or her expected entry and exit schedules until the next day. The electric vehicle 40 may transmit information on an expected plug-in time, an expected plug-out time, the SoC, and the available battery capacity to the electric vehicle charging and discharging management device 30.

The electric vehicle power management system 1 described above is a centralized control system and may adjust the charging and discharging schedule of the electric vehicles by considering the time-based power price or the demand and supply of the power system. However, as the number of electric vehicles to be controlled increases, the computational burden and complexity for optimal scheduling are increasing.

The electric vehicle charging and discharging scheduling apparatus according to the embodiment has a technical effect of being capable of optimizing charging and discharging of such a large-scale electric vehicle fleet. The electric vehicle charging and discharging scheduling apparatus according to the embodiment may be included in a configuration of the electric vehicle charging and discharging management device or may be provided as a separate device. In the case where the electric vehicle charging and discharging scheduling apparatus is provided as a separate device, a separate wired or wireless communication device may be provided for communicating with the electric vehicle, an external server, a terminal, and the like.

In such an embodiment, the electric vehicle charging and discharging scheduling apparatus may be described as being included in the electric vehicle charging and discharging management device 30.

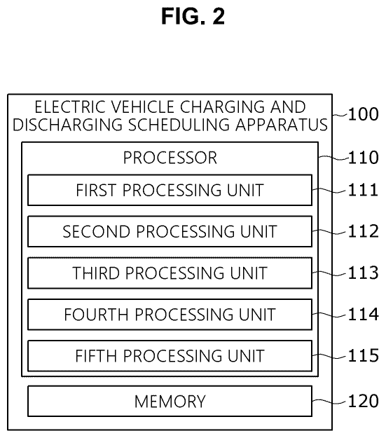

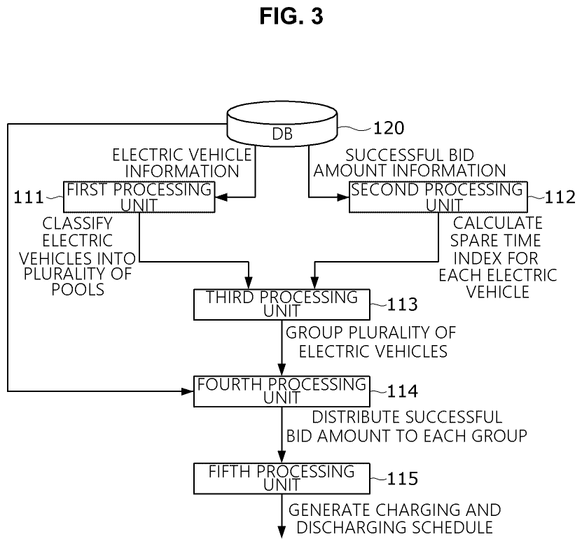

FIG. 2 is a block diagram of a configuration of an electric vehicle charging and discharging scheduling apparatus according to an embodiment, and FIG. 3 is a diagram for describing the operation of the electric vehicle charging and discharging scheduling apparatus according to the embodiment.

Referring to FIGS. 2 and 3, an electric vehicle charging and discharging scheduling apparatus 100 may include a processor 110 and a memory 120. In addition, the processor 110 according to the embodiment may include a first processing unit 111, a second processing unit 112, a third processing unit 113, a fourth processing unit 114, and a fifth processing unit 115.

The electric vehicle charging and discharging scheduling apparatus 100 according to the embodiment may be implemented in a logic circuit by hardware, firmware, software, or a combination thereof, and may also be implemented using a general-purpose or special-purpose computer. The apparatus may be implemented using a hardwired device, a field programmable gate array (FPGA), an application specific integrated circuit (ASIC), or the like. In addition, the apparatus 100 may be implemented as a system on chip (SoC) including one or more processors and controllers.

In addition, the electric vehicle charging and discharging scheduling apparatus 100 may be installed in a computing device or server equipped with hardware elements in the form of software, hardware, or a combination thereof. The computing device or server may refer to various devices including all or some of a communication device such as a communication modem for communicating with various devices or wired/wireless communication networks or the like, a memory for storing data for executing a program, and a microprocessor for executing the program to perform calculations and commands.

The memory 120 may include a database (DB). The memory 120 may be a storage medium (non-transitory storage medium) that stores instructions executed by the processor. The memory 120 may include at least one of storage media such as s random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In the embodiment, the first processing unit 111 to the fifth processing unit 115 may be implemented through the same process, and for convenience of description, the operation of each component will be described separately below.

The processor 110 may include at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

The first processing unit 111 may classify a plurality of electric vehicles into a plurality of pools according to the participating market. The first processing unit 111 may assign a pool ID according to a virtual power plant (VPP), demand response (DR), vehicle-to-home (V2H), and vehicle-to-building (V2B).

The virtual power plant (VPP) refers to a system that connects multiple small-scale distributed energy resources (DERs) into a single integrated network and operates the connected energy sources as if they were a single power plant. The VPP may be made up of various energy sources, including solar power, wind power, small gas turbines, battery storage devices, electric vehicles, chargers, and the like. The VPP may monitor and control a state of each energy source and power production and consumption in real time through a software platform to ensure optimal power supply.

Demand response (DR) is a program to balance power grids by reducing power consumption when power demand reaches its peak or adjusting power usage for each time section, and electric vehicles or charging platforms participating in the DR program may receive incentives from power companies to reduce power usage during a certain time section or change a power usage time.

The vehicle-to-home (V2H) refers to a technology that uses a battery of an electric vehicle as a household power source by supplying the power stored in the battery of the electric vehicle to electrical appliances in the home when the household power demand is high or a power outage occurs in a state where the electric vehicle is charged.

The vehicle-to-building (V2B) is a technology that uses a battery of an electric vehicle as a power source for a commercial building by supplying power stored in the battery of the electric vehicle to the building during a time section when the power demand of the building is high or electricity costs are high while the electric vehicle is being charged in a parking lot of the building.

The first processing unit 111 may assign a pool ID to an electric vehicle registered on the platform according to the participating market.

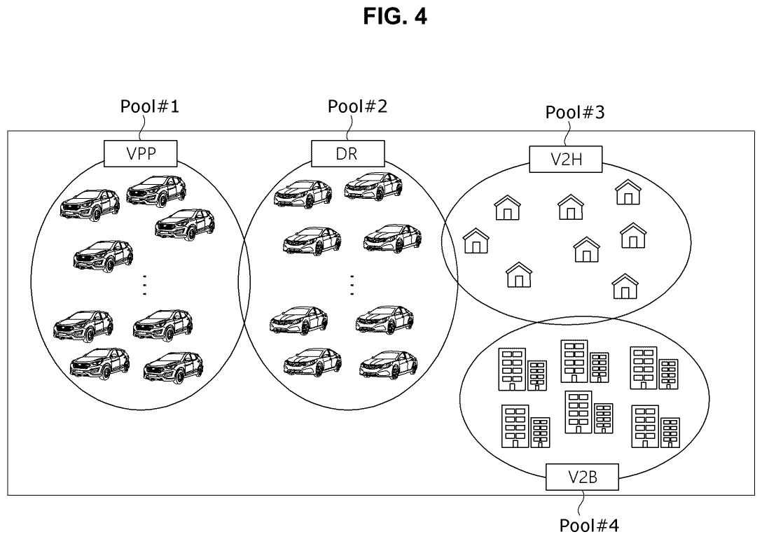

FIG. 4 is a diagram for describing the operation of a first processing unit according to the embodiment. Referring to FIG. 4 together, the first processing unit 111 may assign a pool ID of “1” to a registered electric vehicle participating in a virtual power plant (VPP) market, a pool ID of “10” to a registered electric vehicle participating in a demand response (DR) market, a pool ID of “20” to a registered electric vehicle participating in a vehicle-to-home (V2H) market, and a pool ID of “30” to a registered electric vehicle participating in a vehicle-to-building (V2B) market. The pool ID may variously change depending on settings.

The second processing unit 112 may calculate a spare time index until a target energy completion point in time for each electric vehicle. The second processing unit 112 may calculate a spare time index that is a criterion for clustering and distribution of the successful bid amount for electric vehicles to which a pool ID has been assigned. In the embodiment, the spare time index is an index of a spare time remaining after the electric vehicle has reached a target charge amount in a plug-in state, and may be calculated for each individual electric vehicle. The database may store an expected charging and discharging schedule, specifications, and the like, of an individual electric vehicle, and the second processing unit 112 may derive information such as the expected plug-in time, the expected plug-out time, the SoC, and supplying power of the charger of the individual electric vehicle through the database. In this way, the second processing unit 112 may calculate an entry duration, target energy, and charging energy per hour of the electric vehicle, and may use calculation results to calculate the spare time index.

For example, the second processing unit 112 may calculate the spare time index according to the following Equation 3.

$${LAX}_{i} = {d}_{i} - \frac{{e}_{i}}{{r}_{i}} \qquad [ Equation 3 ]$$

In Equation 3, LAXᵢ is the spare time index, dᵢ is the entry duration [h], eᵢ is the target energy [kWh], and rᵢ is the charging energy per hour [KW]. That is, in Equation 3, LAXᵢ of 0 may mean that the target energy accurately fills the electric vehicle during a remaining time until the electric vehicle exits, “LAXᵢ greater than 0” may mean that there is much spare time to participate in the market after the target energy fills the electric vehicle until the electric vehicle exits, and “LAXᵢ less than 0” may mean that there is no or little spare time to participate in the market after the target energy fills the electric vehicle until the electric vehicle exits.

The third processing unit 113 may group a plurality of electric vehicles according to the spare time index. The third processing unit 113 may group the plurality of electric vehicles using the pool ID and the spare time index. The third processing unit 113 may group the plurality of electric vehicles using a K-means clustering algorithm according to a preset number of electric vehicles for each group.

The K-means clustering is a method of unsupervised learning and is a technique for dividing given data into k clusters. The algorithm may form clusters by assigning each data point to the closest centroid and optimize the quality of clustering by repeatedly recalculating the centroid of each cluster.

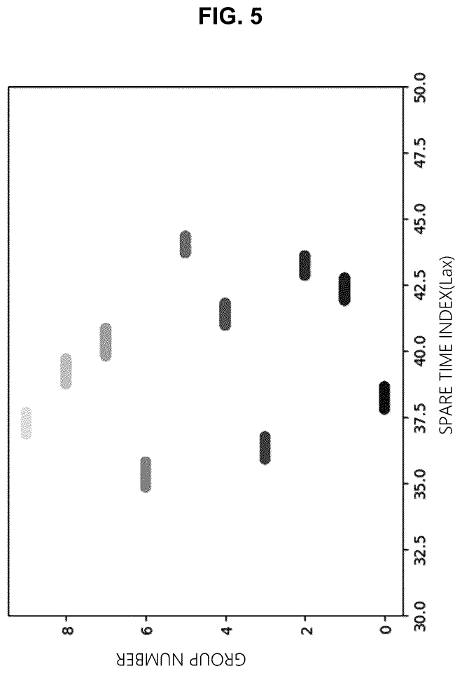

FIG. 5 is a diagram for describing the operation of the third processing unit according to the embodiment. Referring to FIG. 5, the third processing unit 113 may preset the number k of clusters, according to a preset number of electric vehicles for each group. The third processing unit 113 may randomly select k centroids from a data set and assign each data point to a closest centroid to form a cluster. In this case, the data point may be determined as two-dimensional coordinates where a horizontal axis is the spare time index and a vertical axis is a cluster number. The third processing unit 113 may determine a nearby centroid using a distance such as a Euclidean distance or the like.

The third processing unit 113 recalculates the centroid of each cluster as an average of data points belonging to the corresponding cluster, and repeats the recalculation until the centroid no longer changes or the cluster assignment converges.

The third processing unit 113 may terminate the algorithm and return a final cluster and centroid when there is no change in the centroid or when a maximum number of repetitions is reached.

The third processing unit 113 may perform clustering within the classified pools. In the charging and discharging scheduling of the electric vehicle, variables increase as the number of electric vehicles increases. The increase in variables leads to problems such as the increase in dimensions, the increase in computational complexity, and, representatively, the increase in time required. The third processing unit 113 may set an appropriate number of electric vehicles to minimize the cost-related factors and perform clustering.

For example, the third processing unit 113 may calculate the number of groups according to the following Equation 4.

$${N}_{EV}^{G} = {N}_{EV}^{T} // {N}_{G} \qquad [ Equation 4 ]$$

In Equation 4,

$${N}_{EV}^{T}$$

is a total number of electric vehicles registered in an arbitrary pool, N_{G} is a preset number of electric vehicles for each group, and

$${N}_{EV}^{G}$$

is the number of groups.

FIG. 5 is a diagram for describing the operation of the third processing unit 113 according to the embodiment. Referring to FIG. 5 together, when the preset number of electric vehicles for each group is 10 and the total number of electric vehicles registered in the pool is 100, the number of groups may be calculated as 10. The third processing unit 113 may perform clustering so that groups having 10 centroids are formed according to the similarity of the spare time index.

The fourth processing unit 114 may distribute the successful bid amount received from the demand management business operator server to each group using the spare time index. The fourth processing unit 114 may calculate a sum of the spare time indexes for each group and distribute the successful bid amount according to a ratio of the sum.

The electric vehicle charging and discharging scheduling apparatus according to the embodiment bids the charging and discharging amount by time section for 24 hours of a successful bid date on the day before the successful bid date, and receives the successful bid amount every 15 minutes before the successful bid date. Each charging and discharging platform may derive and control the charging or discharging schedule for each electric vehicle based on the successful bid amount.

The fourth processing unit 114 is to distribute the successful bid amount to electric vehicles so that the successful bid amount received from the demand management business operator server every 15 minutes may be fulfilled. In this case, since charging and discharging scheduling is performed for each group, the fourth processing unit 114 distributes the successful bid amount to each group.

The fourth processing unit 114 may consider that the greater the value of the spare time index indicating the spare time of the electric vehicle, the more the electric vehicle may participate in the electricity market, and by distributing the successful bid amount in proportion to the sum of the spare time indexes for each group, a success rate of fulfillment of the successful bid amount may be improved.

For example, the fourth processing unit 114 may distribute the successful bid amount according to the following Equation 5.

$${CPC}_{G} = \frac{{\sum }_{i ∈ G} {LAX}_{í}}{{\sum }_{i ∈ P} {LAX}_{i}} \times {CPC}_{T} \qquad [ Equation 5 ]$$

In Equation 5, i may refer to an electric vehicle, G may represent a group, and P may represent a pool. LAXᵢ may refer to the spare time index of an ith electric vehicle, CPC_{T} may refer to a total successful bid amount of electric vehicles belonging to a P pool in a corresponding time section, and CPC_{G} may refer to the successful bid amount [kWh] of a G group. That is, the fourth processing unit 114 first calculates a total sum of the spare time indexes of electric vehicles belonging to a specific pool, and then calculates the spare time index for each of groups belonging to the corresponding pool. Next, the fourth processing unit 114 may calculate a ratio value of the spare time index for each group to the total sum of the spare time indexes, and then distribute the total successful bid amount of the corresponding pool according to the ratio value of the spare time index to calculate the successful bid amount for each group.

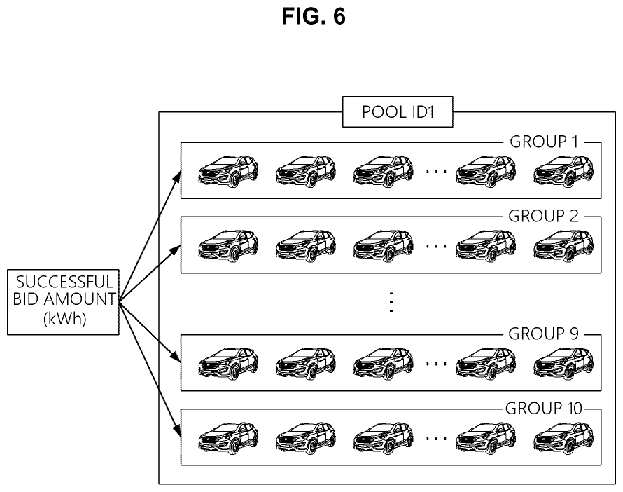

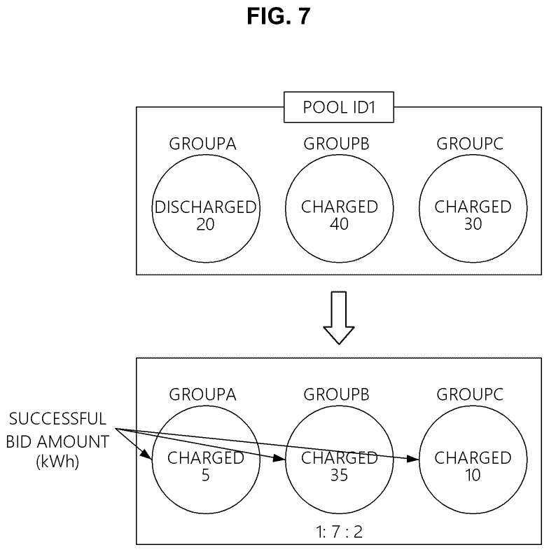

FIGS. 6 and 7 are diagrams for describing the operations of the third processing unit and the fourth processing unit according to the embodiment.

Referring to FIG. 6 together, the fourth processing unit 114 may distribute the total successful bid amount of a VPP pool whose pool ID is 1 to each group. Referring to FIG. 7 together, three groups are formed in the VPP pool, a bid amount of group A is 20 [kWh] for discharging, a bid amount of group B is 40 [kWh] for charging, and a bid amount of group C is 30 [kWh] for charging. Therefore, a total bid amount of the VPP pool may be calculated as a sum of charging and discharging amounts of the three groups, which is 50 [kWh] of charging.

The third processing unit 113 may calculate the spare time index for each group. The third processing unit 113 calculates the spare time index of group A as 10, the spare time index of group B as 70, and the spare time index of group C as 20. The fourth processing unit 114 calculates the ratio of the spare time indexes of the respective groups as 1:7:2 (Group A:Group B:Group C). The fourth processing unit 114 may multiply the ratio of the spare time index by the total successful bid amount of 50 [kWh] to distribute the successful bid amount of group A as 5 [kWh] for charging, the successful bid amount of group B as 35 [kWh] for charging, and the successful bid amount of group C as 10 [kWh] for charging.

The fifth processing unit 115 may generate a charging and discharging schedule for the electric vehicle using the successful bid amount distributed to each group. The fifth processing unit 115 may generate the charging and discharging schedule to maximize the profit of electric vehicles belonging to the corresponding group according to the successful bid amount for each group. The fifth processing unit 115 may output a signal for controlling charging and discharging of an individual electric vehicle according to the generated charging and discharging schedule.

The fifth processing unit 115 may set the charging and discharging schedule of an individual electric vehicle belonging to each group using the successful bid amount of the electric vehicles for each group. The fifth processing unit 115 may subdivide the charging and discharging schedule of the individual electric vehicle belonging to each group based on the successful bid amount distributed based on a clustered group. In this case, the charging and discharging schedule may be set by considering an individual operating condition of each electric vehicle. That is, the charging and discharging schedule may refer to a charging and discharging schedule of an individual electric vehicle belonging to a group.

In embodiments, various objective functions may be applied for optimal charging and discharging scheduling. For example, goals such as minimizing electricity costs, maximizing battery life, or optimizing the load on the power grid may be applied.

For example, the fifth processing unit 115 may set the charging and discharging schedule to follow a target battery capacity of the individual electric vehicle based on the successful bid amount for each group. The fifth processing unit 115 may set the charging and discharging schedule so that the sum of the charging and discharging amounts of the individual electric vehicles within the group through the charging and discharging schedule is equal to the successful bid amount for each group.

The charging and discharging schedule may include a charging power amount and a discharging power amount of the individual electric vehicle for each group. In this case, the fifth processing unit 115 may determine the charging and discharging power amounts of the individual electric vehicle to follow a target SoC of the individual electric vehicle. The fifth processing unit 115 may set the charging and discharging schedule so that a difference value between the SoC of the electric vehicle and the target SoC is a minimum value after actual charging or discharging according to the charging and discharging schedule. In this case, the fifth processing unit 115 may set an SoC upper limit value and an SoC lower limit value according to an available capacity range of the battery of the individual electric vehicle, and set the charging and discharging schedule so that the electric vehicle may be charged and discharged within the range of the SoC upper limit value and SoC lower limit value.

For example, the fifth processing unit 115 may set a difference value between the SoC of the electric vehicle after charge and discharge control and the target SoC as an objective function and minimize the difference value through an optimization process of the set objective function.

Alternatively, the fifth processing unit 115 may set the charging and discharging schedule so that a profit through a sum of a charging fee and a discharging profit is maximized. For example, the fifth processing unit 115 may set a combined cost of the cost of purchasing electricity for charging after the charge and discharge control and the cost of selling electricity through discharging as the objective function and minimize the difference value through the optimization process of the set objective function.

The fifth processing unit 115 may perform the optimization of the objective function by applying the gradient descent method, the steepest descent method, the mixed integer programming (MIP) method, or the stochastic gradient descent method.

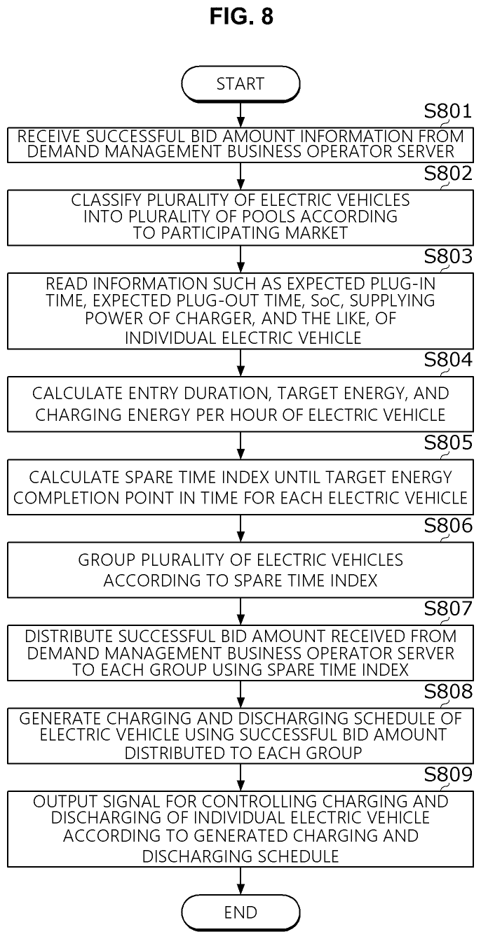

FIG. 8 is a flowchart of a method of charging and discharging scheduling of an electric vehicle according to an embodiment.

Referring to FIG. 8, the processor receives successful bid amount information from the demand management business operator server through a communication device. The successful bid amount information is a charging and discharging amount by time section for 24 hours that is bidden on the day before a successful bid date, and a successful bid amount may be received every 15 minutes before the successful bid date (S801).

A plurality of electric vehicles may be classified into a plurality of pools based on a participating market. The processor may assign a pool ID to an electric vehicle registered on a platform according to the participating market. For example, the processor may assign the pool ID according to a virtual power plant (VPP), demand response (DR), vehicle-to-home (V2H), and vehicle-to-building (V2B) (S802).

Next, the processor may read information such as an expected plug-in time, an expected plug-out time, an SoC, supplying power of a charger, and the like, of an individual electric vehicle through a database (S803).

Next, the processor may use information such as the expected plug-in time, the expected plug-out time, the SoC, the supplying power of the charger, and the like, of the individual electric vehicle to calculate an entry duration, target energy, and charging energy per hour of the electric vehicle. The entry duration of the electric vehicle may be calculated using the expected plug-in time and expected plug-out time of the individual electric vehicle, the target energy may be calculated from the SoC, and the charging energy per hour may be calculated from the supplying power of the charger (S804).

Next, the processor calculates a spare time index for each electric vehicle until a target energy completion point in time. The processor may calculate the spare time remaining after supplying target energy through the charger during the entry duration as the spare time index (S805).

Next, the processor groups a plurality of electric vehicles based on the spare time index. The processor may group the plurality of electric vehicles using a pool ID and the spare time index. For example, the processor may group the plurality of electric vehicles using a K-means clustering algorithm according to a preset number of electric vehicles for each group (S806).

Next, the processor may distribute the successful bid amount received from the demand management business operator server to each group using the spare time index. The processor may calculate a sum of the spare time indexes for each group and distribute the successful bid amount according to the ratio of the sum (S807).

Next, the processor generates a charging and discharging schedule for the electric vehicle using the successful bid amount distributed to each group. The processor may generate the charging and discharging schedule to maximize the profit of electric vehicles belonging to a corresponding group based on the successful bid amount for each group (S808).

Next, the processor outputs a signal that controls charging and discharging of individual electric vehicles according to the generated charging and discharging schedule (S809).

The term “unit” used in the present embodiment refers to software component or hardware components such as a field-programmable gate array (FPGA) or an application specific integrated circuit (ASIC), and “unit” performs certain functions. However, “unit” is not limited to software or hardware. “unit” may be configured to be in an addressable storage medium, or may be configured to reproduce one or more processors. Therefore, for example, “unit” may include components such as software components, object-oriented software components, class components, and task components, and may include processes, functions, attributes, procedures, sub-routines, segments of program code, drivers, firmware, micro codes, circuits, data, a database, data structures, tables, arrays, and variables. Functions provided in the components and the “unit” may be coupled with lesser numbers of components and “units,” or may be further divided into additional components and “units.” Furthermore, the components and “units” may be implemented to reproduce one or more CPUs in a device or a security multimedia card.

An apparatus and method for charging and discharging scheduling of an electric vehicle according to an embodiment can group electric vehicle resources to reduce the time cost of an electric vehicle charging and discharging platform.

In addition, the electric vehicle resources can be managed to satisfy a successful bid amount received in an electricity market in which the electric vehicle participates.

In addition, the time cost of the electric vehicle charging and discharging platform can be minimized.

In addition, an optimal charging and discharging schedule for the electric vehicle platform can be derived.

Although the preferred embodiments of the present disclosure have been described above, it is understood that those skilled in the art can make various changes and modifications to the present disclosure without departing from the spirit and scope of the present disclosure set forth in the claims below.

1. An apparatus for charge and discharge scheduling of an electric vehicle, comprising:
one or more processors; and
a memory storing one or more programs executed by the one or more processors, wherein each of the processors includes:
a first processing unit configured to classify a plurality of electric vehicles into a plurality of pools according to a participating market;
a second processing unit configured to calculate a spare time index until a target energy completion point in time for each electric vehicle;
a third processing unit configured to group the plurality of electric vehicles according to the spare time index; and
a fourth processing unit configured to distribute a successful bid amount received from a demand management business operator server to each group using the spare time index.

2. The apparatus of claim 1, wherein the second processing unit calculates the spare time index using an entry duration, a target energy value, and a charging energy per hour value of the electric vehicle.

3. The apparatus of claim 2, wherein the second processing unit calculates the spare time index according to:
$${LAX}_{i} = {d}_{i} - \frac{{e}_{i}}{{r}_{i}} ,$$
wherein LAXᵢ is the spare time index, dᵢ is the entry duration [h], eᵢ is the target energy [kWh], and rᵢ is the charging energy per hour [kW].

4. The apparatus of claim 1, wherein the first processing unit assigns a pool ID to the electric vehicle according to the participating market.

5. The apparatus of claim 4, wherein the third processing unit groups the plurality of electric vehicles according to the pool ID and the spare time index.

6. The apparatus of claim 5, wherein the third processing unit groups the plurality of electric vehicles according to a K-means clustering algorithm based on a preset number of electric vehicles for each group.

7. The apparatus of claim 5, wherein the first processing unit assigns the pool ID according to a virtual power plant (VPP), a demand response (DR), a vehicle-to-home (V2H), and a vehicle-to-building (V2B).

8. The apparatus of claim 1, wherein the fourth processing unit calculates a sum of the spare time indexes for each group and distributes the successful bid amount according to a ratio of the sum.

9. The apparatus of claim 1, further comprising a fifth processing unit configured to generate a charging and discharging schedule for the electric vehicle using the successful bid amount distributed to each group.

10. The apparatus of claim 9, wherein the fifth processing unit generates the charging and discharging schedule so that a profit of the electric vehicle belonging to the group is maximized according to the successful bid amount for each group.

11. A method performed by a computing device having one or more processors and a memory storing one or more programs executed by the one or more processors, comprising:
classifying, by the processor, a plurality of electric vehicles into a plurality of pools according to a participating market;
calculating, by the processor, a spare time index until a target energy completion point in time for each electric vehicle;
grouping, by the processor, the plurality of electric vehicles according to the spare time index; and
distributing, by the processor, a successful bid amount received from a demand management business operator server to each group using the spare time index.

12. The method of claim 11, wherein the calculating of the spare time index comprises using an entry duration, target energy, and charging energy per hour of the electric vehicle.

13. The method of claim 12, wherein the calculating of the spare time index, is
$${LAX}_{i} = {d}_{i} - \frac{{e}_{i}}{{r}_{i}} ,$$
according to:
wherein LAXᵢ is the spare time index, dᵢ is the entry duration [h], eᵢ is the target energy [kWh], and rᵢ is the charging energy per hour [kW].

14. The method of claim 11, wherein the classifying of the plurality of electric vehicles into the plurality of pools includes assigning a pool ID to the electric vehicle according to the participating market.

15. The method of claim 14, wherein in the grouping, the plurality of electric vehicles are grouped using the pool ID and the spare time index.

16. The method of claim 15, wherein in the grouping, the plurality of electric vehicles are grouped using a K-means clustering algorithm according to a preset number of electric vehicles for each group.

17. The method of claim 15, wherein the classifying of the plurality of electric vehicles into the plurality of pools includes assigning, by the processor, the pool ID according to a virtual power plant (VPP), demand response (DR), vehicle-to-home (V2H), and vehicle-to-building (V2B).

18. The method of claim 11, wherein in the distributing of the successful bid amount to each group, the processor calculates a sum of the spare time indexes for each group and distributes the successful bid amount according to a ratio of the sum.

19. The method of claim 11, further comprising generating, by the processor, a charging and discharging schedule for the electric vehicle using the successful bid amount distributed to each group.

20. The method of claim 19, wherein in the generating of the charging and discharging schedule, the charging and discharging schedule is generated so that a profit of the electric vehicle belonging to the group is maximized according to the successful bid amount for each group.
